(19) United States
(12) Patent Application Publication
(10) Pub. No.: US 2026/0158765 A1
(43) Pub. Date: Jun. 11, 2026

(54) LITHIUM METAL MANUFACTURING USING MASK LAYER

(71) Applicant: Soelect Inc., Greensboro, NC (US)

(72) Inventor: Sungjin Cho, Summerfield, NC (US)

(21) Appl. No.: 19/414,787

(22) Filed: Dec. 10, 2025

Related U.S. Application Data
(60) Provisional application No. 63/730,223, filed on Dec. 10, 2024.

(51) Int. Cl. B32B 15/01; B32B 3/14; B32B 15/20; B32B 37/00; B32B 37/10; B32B 37/30

(52) U.S. Cl. CPC B32B 15/01; B32B 3/14; B32B 15/20; B32B 37/0053; B32B 37/10; B32B 37/30; B32B 2250/02; B32B 2250/44; B32B 2309/12; B32B 2457/10

(57) ABSTRACT

The present disclosure provides a patterned film for guiding lithium metal during lamination, including first and second regions having different thicknesses configured to direct selective placement, deformation, separation, and transfer of lithium metal onto substrates during roll pressing without mechanical slitting, punching, notching, or trimming. The patterned film may include concave configurations where thin regions form recessed cavities between thick regions, or convex configurations where thick regions form raised sections above thin regions. Methods involve positioning lithium metal adjacent to the patterned film, applying pressure through roll pressing to direct lithium according to the geometry defined by thick and thin regions, and transferring lithium onto substrates. Roll press-based fabrication systems include the patterned film, lithium metal feed layer, substrate, and roller units configured to apply selective pressure for lithium transfer according to the film pattern.

### CROSS-REFERENCE TO RELATED APPLICATIONS

This application claims priority to U.S. Provisional Patent Application No. 63/730,223, filed Dec. 10, 2024, which is hereby incorporated by reference in its entirety.

### TECHNICAL FIELD

The present disclosure relates to lithium metal processing and electrode fabrication, and more particularly to patterned film guided lamination techniques that shape, separate, and transfer lithium metal onto metallic or non-metallic substrates through controlled roll press operations without mechanical slitting, punching, notching or trimming.

### BACKGROUND

Lithium metal has emerged as a promising anode material for high-energy rechargeable batteries due to its low electrochemical potential and high theoretical capacity. These properties make lithium metal anodes attractive for next-generation battery technologies that demand increased energy density and improved performance characteristics. However, the manufacturing of thin lithium metal structures for battery applications presents several technical challenges. Conventional production methods typically involve uniform rolling of lithium foil to achieve desired thickness, followed by mechanical operations such as slitting, trimming, or punching to obtain required geometries. Notably, these mechanical processing steps add complexity to the manufacturing process, increase equipment costs, and generate material waste that reduces overall production efficiency.

Traditional rolling processes apply uniform pressure across the entire lithium surface, which can result in inconsistent adhesion between the lithium metal and substrate materials such as copper foil. Poor adhesion quality can lead to delamination during handling and processing, compromising the structural integrity of the final electrode assembly. Additionally, conventional lamination methods may not provide adequate control over the interfacial bonding characteristics between lithium metal and substrate materials.

The production of advanced lithium anode designs often requires intermittent or patterned lithium geometries rather than continuous uniform coatings. Creating such patterned structures using conventional methods typically involves multiple cutting steps, specialized equipment, and customized tooling. These requirements increase capital investment and limit the flexibility to rapidly modify lithium patterns for different battery specifications or customer requirements. Material utilization efficiency represents another consideration in lithium metal processing. Conventional methods may leave residual lithium on processing equipment or release films that cannot be easily recovered, leading to material loss and increased operating expenses. The ability to recover and recycle unused lithium would provide both economic and environmental benefits.

Manufacturing systems that can eliminate mechanical cutting operations while providing improved adhesion characteristics and enhanced process flexibility would offer advantages for lithium metal electrode production. Such systems could reduce equipment requirements, improve material utilization, and enable rapid adaptation to various cell specifications and design requirements.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a patterned film for guiding lithium metal during a lamination process is provided. The patterned film comprises a first region having a first thickness and a second region having a second thickness different from the first thickness. The first region and the second region are configured to direct selective placement, deformation, separation, and transfer of lithium metal onto a substrate during roll pressing without mechanical slitting, punching, notching, or trimming.

According to other aspects of the present disclosure, the patterned film may include one or more of the following features. The first region may comprise a thick region and the second region may comprise a thin region. The thin region may form a recessed cavity between surrounding thick regions in a concave configuration. The thick region may form a raised section above surrounding thin regions in a convex configuration. The patterned film may comprise a thickness between 5 micrometers and 5 centimeters. The patterned film may comprise a material selected from polymers, metals, composites, ceramics, or multilayer structures. The material may comprise a polymer selected from polyester, polyethylene, polypropylene, polyacrylonitrile, polyvinylidene fluoride, polyvinyl chloride, polytetrafluoroethylene, nylon, polyurethane, cellulose films, lignin-based films, rubber-based sheets, fluoropolymer compositions, or combinations thereof.

According to another aspect of the present disclosure, a method for forming a patterned lithium structure is provided. The method comprises positioning a lithium metal layer adjacent to a patterned film having at least one thick region and at least one thin region. The method comprises applying pressure through roll pressing to direct the lithium metal to move, deform, accumulate, or separate according to a geometry defined by the thick region and the thin region of the patterned film. The method comprises transferring the lithium metal positioned within a patterned region onto a substrate without mechanical slitting, punching, notching, or trimming.

According to other aspects of the present disclosure, the method may include one or more of the following features. The patterned film may comprise a concave arrangement having a recessed thin region that receives lithium during compression. Excess lithium residing outside the thin region may be retained on a release film for subsequent recovery. The patterned film may comprise a convex arrangement having a raised thick region that concentrates pressure for selective separation. The raised thick region may generate localized pressure that produces selective lifting of the lithium metal. The substrate may comprise a metallic material selected from copper, aluminum, nickel, stainless steel, or combinations thereof. The patterned film may comprise an A-Metal-A configuration positioned directly on the metallic material, and the applying pressure and the transferring may be performed simultaneously in a single pass through a roll press.

According to another aspect of the present disclosure, a roll press-based fabrication system for producing patterned lithium metal structures is provided. The system comprises a patterned film having controlled thickness regions including at least one thick region and at least one thin region. The system comprises a lithium metal feed layer. The system comprises a substrate. The system comprises a roller unit configured to apply selective pressure that transfers lithium metal according to a pattern of the patterned film without mechanical slitting, punching, notching, or trimming.

According to other aspects of the present disclosure, the system may include one or more of the following features. The roller unit may be configured to apply pressure between one megapascal and two hundred megapascal. The substrate may comprise a metallic material selected from copper, aluminum, nickel, stainless steel, magnesium, zinc, tin, antimony, beryllium, bismuth, lead, cadmium, chromium, cobalt, manganese, titanium, zirconium, hafnium, vanadium, molybdenum, tungsten, silver, gold, indium, gallium, germanium, palladium, platinum, silicon, metal coated polymer films, or combinations thereof. The patterned film may be configured to provide a peel strength at least 50% greater than that of a lamination performed using an intermittent electrode design without the patterned film, or a delamination rate of lithium metal remaining on the patterned film may be less than 10%. The patterned film may comprise a concave arrangement having a recessed thin region configured to receive lithium metal during compression, or a convex arrangement having a raised thick region configured to concentrate pressure for selective lithium separation. The system may be configured to produce intermittent lithium patterns comprising two or more separated lithium segments with defined spacing between the segments.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates patterned film structures with concave and convex thickness variations, according to aspects of the present disclosure.

FIG. 2 depicts a concave patterned film lamination system for processing lithium metal, according to aspects of the present disclosure.

FIG. 3 is a diagram illustrating a photographic sequence demonstrating the concave patterned film lamination process of FIG. 2, according to aspects of the present disclosure.

FIG. 4 depicts a convex patterned film lamination system for processing lithium metal, according to aspects of the present disclosure.

FIG. 5 is a diagram that illustrates a photograph sequence demonstrating the convex patterned film lamination process of FIG. 4, according to aspects of the present disclosure.

FIG. 6 depicts a direct lamination process with a patterned film positioned on a metallic substrate, according to aspects of the present disclosure.

FIG. 7 is a diagram illustrating a photographic sequence demonstrating the lithium to metal direct lamination process using the patterned film of FIG. 6, according to aspects of the present disclosure.

FIG. 8 depicts a top view and side view of patterned lithium metal on a substrate with defined spacing between lithium sections, according to aspects of the present disclosure.

FIG. 9 illustrates a table presenting peel strength data comparing different lithium metal lamination methods, according to aspects of the present disclosure.

FIG. 10 depicts a flowchart for manufacturing patterned lithium metal structures using a patterned mask layer, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to patterned film guided lamination processes for manufacturing lithium metal structures. The processes may utilize patterned films comprising regions of varying thickness to control pressure distribution during roll pressing operations. The controlled pressure distribution may enable selective placement, deformation, and transfer of lithium metal onto substrates without mechanical cutting operations such as slitting, punching, notching, or trimming.

The patterned films (or “patterned mask layers”) may comprise at least two distinct thickness regions that function cooperatively to direct lithium metal flow during lamination. A first region may have a first thickness, and a second region may have a second thickness different from the first thickness. The thickness variations between the regions may create controlled pressure zones that determine the final geometry and placement of lithium metal on target substrates. The patterned films may be fabricated from polymers, metals, composites, ceramics, or multilayer structures that maintain structural integrity during compression operations. In some cases, the patterned films may include concave configurations where thin regions form recessed areas between surrounding thick regions (e.g., a thick area-thin recessed area-thick area mask, or “A-B-A” mask). The recessed areas may receive and contain lithium metal when pressure is applied during lamination, while the thick regions may provide structural boundaries that prevent unintended spreading of lithium beyond designated areas. The concave configuration may enable guided flow of lithium metal into controlled volumes, producing lithium structures with defined geometric boundaries.

Alternatively, the patterned films may include convex configurations where thick regions form raised sections above surrounding thin regions (e.g., a thin area-thick raised area-thin area mask, or “B-A-B” mask). The raised sections may concentrate pressure on specific portions of lithium metal during roll pressing, facilitating selective lifting and controlled separation. The thin regions may provide flexible support areas that allow deformation while maintaining film stability during processing operations.

The patterned film guided lamination processes disclosed herein may eliminate the need for conventional mechanical cutting equipment typically used in lithium metal manufacturing. Traditional methods may rely on uniform rolling followed by slitting, trimming, or punching operations to achieve desired geometries. These mechanical operations may increase process complexity, raise equipment costs, and generate scrap materials. In contrast, the disclosed patterned film approach may achieve precise lithium shaping during the lamination step, thereby reducing manufacturing complexity and equipment requirements.

The processes may also enhance adhesion between lithium metal and substrates compared to conventional uniform lamination methods. The controlled pressure distribution created by the patterned films may concentrate compression forces at specific interface regions, promoting stronger mechanical bonding. The enhanced adhesion may reduce delamination rates and improve the mechanical stability of lithium metal structures on substrates.

Manufacturing flexibility may be achieved through the ability to modify patterned film designs to accommodate different lithium geometries and dimensions. Pattern modifications may enable rapid adaptation to various battery specifications without requiring changes to mechanical cutting equipment. The approach may support both continuous and intermittent lithium patterns, including structures with defined spacing between lithium segments.

Moreover, the disclosed processes may also enable complete recovery of residual lithium material that remains on patterned films after transfer operations. The residual lithium may be removed through physical or chemical methods, providing a recycling pathway that reduces material waste and improves resource utilization. The recycling capability may contribute to environmentally favorable manufacturing practices while reducing operating costs associated with lithium material loss.

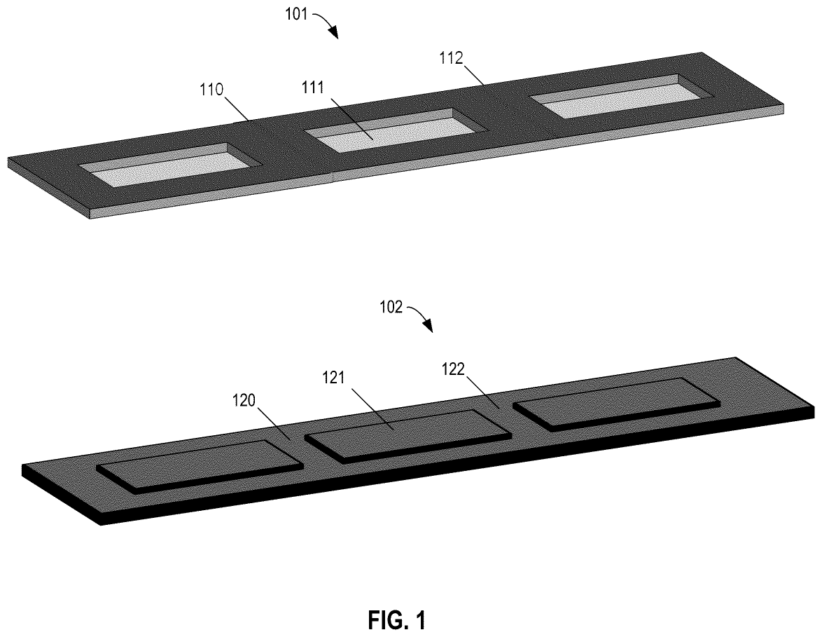

Referring to FIG. 1, two representative patterned film structures may be utilized for selective lithium placement during lamination processes. FIG. 1 illustrates a concave patterned film 101 and a convex patterned film 102, each demonstrating distinct thickness variation patterns designed to control lithium metal distribution during roll pressing operations.

In some embodiments, the concave patterned film 101 (e.g., “A-B-A” mask) may exhibit an alternating thickness structure comprising a thick region 110, a recessed thin region 111, and a thick region 112, arranged sequentially (and repeatedly) along the length of the film or mask. In this configuration, the recessed thin region(s) 111 may form recessed cavities between the surrounding thick regions 110 and 112. The thick regions 110 and 112 may provide structural boundaries that define areas where lithium metal may be guided during compression. The recessed thin region(s) 111 may create controlled volumes that receive and contain lithium metal when pressure is applied during lamination, preventing unintended spreading beyond designated boundaries. More specifically, during lamination, only the lithium residing within the recessed cavity is transferred to the substrate, producing a clean and uniform lithium pattern.

FIG. 1 further depicts a convex patterned film 102 that presents an inverse thickness arrangement comprising a thin region 120, a raised thick region 121, and a thin region 122 that are arranged sequentially (and repeatedly). In this structure, the raised thick region(s) 121 may form raised sections that protrude above the surrounding thin regions 120 and 122. In some embodiments, the raised thick regions 121 may concentrate pressure on specific portions of lithium metal during roll pressing, thereby enabling selective lifting and controlled separation. The thin regions 120 and 122 may provide flexible support areas that allow deformation while maintaining film stability during processing operations. In contrast to the concave structure, the convex mask promotes lithium transfer from elevated zones and relocates excess lithium to the lower areas of the carrier layer. This structure is particularly effective for producing thin and sharply defined lithium patterns. The raised geometry stabilizes the contact area and supports accurate, high-speed transfer without the need for mechanical slitting.

Both patterned film structures of films 101 and 102 may demonstrate repeating geometric patterns that enable continuous roll-to-roll manufacturing operations. The disclosed system may support a continuous roll-to-roll operation and may provide precise control over pattern geometry, thickness stability, and edge definition. Notably, the concave patterned film 101 may direct lithium metal into recessed areas through guided flow under compression, while the convex patterned film 102 may apply concentrated pressure through raised sections to achieve selective lithium transfer. Together, these structures offer a controlled interface that improves pattern accuracy, strengthens adhesion during transfer, and minimizes the formation of defects, such as irregular edges or uneven lithium distribution.

The thickness variations between the thick regions 110, 112, 121 and the thin regions 111, 120, 122 may establish controlled pressure distribution zones that determine the final geometry and placement of lithium metal on substrates without requiring mechanical cutting operations. In some embodiments, the patterned films may comprise a thickness between 5 micrometers (μm) and 5 centimeters (cm), providing sufficient structural integrity for roll pressing operations while maintaining flexibility for pattern formation.

The patterned films may be prepared from polymers, metals, composites, ceramics, or multilayer structures. The film materials may maintain structural integrity during roll pressing operations while providing the necessary thickness variations for controlled pressure distribution. As used herein, polymer materials may include polyester, polyethylene, polypropylene, polyacrylonitrile, polyvinylidene fluoride, polyvinyl chloride, polytetrafluoroethylene, nylon, polyurethane, cellulose films, lignin-based films, rubber-based sheets, or fluoropolymer compositions. Metal materials may include aluminum, copper, nickel, magnesium, zinc, titanium, tungsten, silver, gold, platinum, or stainless steel films. Composite materials may combine polymer matrices with reinforcing fibers or particles. Ceramic materials may include oxide or carbide compositions suitable for high-pressure applications. Multilayer structures may combine different material types to achieve desired mechanical properties and pattern definition capabilities.

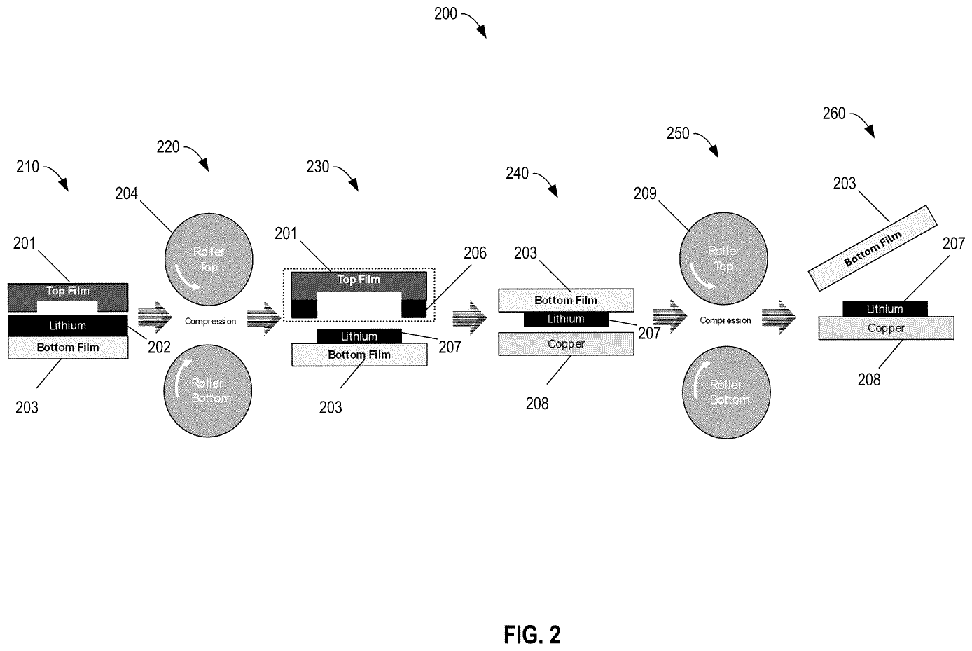

Referring to FIG. 2, a concave patterned film lamination system 200 may be utilized for processing lithium metal through sequential compression and transfer operations. The system 200 may progress through multiple stages (e.g., stages 210-260) to achieve controlled lithium metal patterning and transfer onto substrates.

In some embodiments, the system 200 may begin at an initial stage 210, where a lithium layer 202 may be positioned between the top film 201 (e.g., “A-B-A” mask) and a bottom film 203. The top film 201 may include a concave patterned structure with recessed regions that define the intended lithium placement area, while surrounding thicker portions may stabilize the film during compression. One example of top film 201 is depicted as film 101 in FIG. 1. At the initial stage 210, the three layers (e.g., “layered assembly”) may be aligned in preparation for compression operations.

The system 200 may subsequently advance to an initial compression stage 220, where the layered assembly may be compacted by a first roller device 204 (e.g., a single roller or pair of rollers as shown in FIG. 2). During the initial compression stage 220, the roller device 204 may apply pressure to the stacked layers, causing the lithium layer 202 to deform and flow according to the pattern defined by the top film 201. The thick regions of the top film 201 may act as a structural frame to restrict lateral spreading of the lithium, while the thin regions may allow selective lithium accumulation within the recessed areas. This guided flow produces a sharply defined lithium pattern that matches the geometry of the recessed region.

Following compression, the system 200 may enter a separation stage 230. At the separation stage 230, the original layered assembly may be separated such that lithium side portions 206 may adhere to the thick regions of the top film 201 (which may function as a release film for the excess material) and be detached and/or removed from the original lithium layer 202. Notably, a remaining lithium layer 207 may remain adhered to the bottom film 203. The concave patterned structure of the top film 201 may facilitate a clean separation of the lithium portions, with the remaining lithium layer 207 conforming to the geometry defined by the recessed regions of the top film 201. The bottom film 203 retains the lithium pattern temporarily and carries it to the next phase of the process.

The system 200 may then proceed to a lamination stage 240, where the bottom film 203 carrying the remaining lithium layer 207 may be brought into contact with a copper substrate 208. Although a copper substrate is described and depicted in FIG. 2, other types of metallic or non-metallic substrates may be used without departing from the scope of the disclosed subject matter. The remaining lithium layer 207 may be positioned between the bottom film 203 and the copper substrate 208 in preparation for transfer operations.

At a second compression stage 250, the assembly (i.e., comprising the bottom film, remaining lithium layer, and copper substrate) may pass through and be compacted by a second roller device 209 (e.g., a single roller or a pair of rollers as shown in FIG. 2). The roller device 209 may apply pressure to promote adhesion between the remaining lithium layer 207 and the copper substrate 208. The compression may enhance interfacial bonding and may facilitate transfer of the lithium from the bottom film 203 to the copper substrate 208, allowing the formation of a continuous lithium to copper interface with uniform thickness and clean edges.

The system 200 may conclude at a final stage 260, where the bottom film 203 may be separated from the remaining lithium layer 207 and the copper substrate 208. Notably, the remaining lithium layer 207 may be bonded or adhered to the copper substrate 208 in a patterned configuration that corresponds to the geometry originally defined by the top film 201. The system 200 may demonstrate a continuous process flow that enables patterned lithium metal formation and transfer without mechanical cutting operations. This process reduces the formation of irregularities such as wrinkles, uneven edges, or uncontrolled spreading of lithium. Overall, the coordinated use of patterned geometry, film rigidity, and sequential roller compression produces a high precision transfer mechanism that supports uniform coating quality and material efficiency in lithium metal manufacturing.

In some embodiments, the roller devices 204 and 209 may be configured to apply pressure ranging between one Megapascal (MPa) and 200 MPa during compression operations. The pressure range may provide sufficient force for lithium deformation and substrate adhesion while maintaining structural integrity of the patterned films and substrate materials.

In some embodiments, the copper substrate 208 may instead be any substrate type that comprises metallic materials selected from copper, aluminum, nickel, stainless steel, magnesium, zinc, tin, antimony, beryllium, bismuth, lead, cadmium, chromium, cobalt, manganese, titanium, zirconium, hafnium, vanadium, molybdenum, tungsten, silver, gold, indium, gallium, germanium, palladium, platinum, silicon, their alloys, metal coated polymer films, metal coated glass films, clad metal foils, sintered metal sheets, porous metal foams, or combinations thereof.

In some embodiments, the substrate may comprise nonmetallic materials selected from polyester including polyethylene terephthalate, polyethylene, polypropylene, polyacrylonitrile, polyvinylidene fluoride, polyvinyl chloride, polytetrafluoroethylene, nylon, polyurethane, silicone coated polymer films, fluoropolymer coated films, cellulose films, lignin based films, rubber based sheets, synthetic polymer laminates, paper based release liners, ceramic coated polymer films, glass coated polymer films, or combinations thereof. The nonmetallic substrate materials may provide alternative surface properties for specific lithium metal applications where metallic substrates may not be suitable.

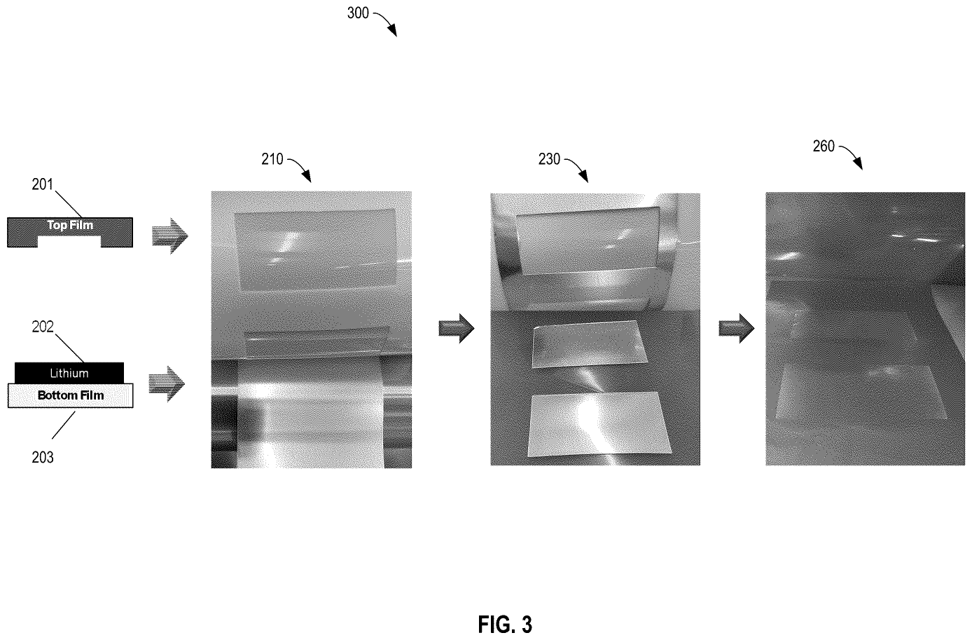

Referring to FIG. 3, diagram 300 illustrates a photographic sequence demonstrating the practical application of the concave patterned film lamination process with lithium metal. Diagram 300 presents a sequence of images that correspond to some of the stages described in the system 200, providing visual evidence of the controlled lithium placement and transfer operations achieved through the concave mask or film structure (e.g., A-B-A mask).

At the initial stage 210, diagram 300 shows the top film 201 positioned above the bottom film 203 with lithium metal layer 202 positioned between the films. The top film 201 may include the concave patterned structure with recessed regions that define the intended lithium placement area during subsequent compression operations. The bottom film 203 may serve as a carrier layer supporting the lithium metal during the lamination process. At this stage, the three layers may be aligned and prepared for compaction by one or more compression rollers without yet being laminated together. This configuration establishes the structural arrangement necessary for a selective transfer process.

The diagram 300 may demonstrate the progression to the separation stage 230, where the layered assembly may have passed through compression rollers and the lithium metal may have been guided into the recessed regions of the top film 201. The interaction between the patterned top film and the lithium layer directs the metal only into the designated recessed area. The image also shows the lithium layer that may have been separated from excess lithium sections through the controlled pressure distribution created by the concave pattern. The concave structure may create distinct boundaries that separate desired lithium segments from excess material, producing cleanly defined geometric shapes without requiring mechanical cutting operations. The top patterned film retains its cavity structure after performing the separation function.

At the final stage 260 shown in FIG. 3, diagram 300 presents the completed transfer of patterned lithium segments onto a substrate surface. Pressure increases the adhesion between lithium and copper, allowing the lithium to detach from the bottom film and remain securely on the metallic substrate, The transferred lithium structures may exhibit uniform thickness, smooth edges, and precise geometric boundaries that correspond to the recessed regions defined by the concave patterned top film 201. The photographic sequence may demonstrate the progression from initial alignment through compression-guided separation to final transfer, illustrating how the concave A-B-A patterned film structure may direct lithium placement during roll press lamination operations.

Notably, diagram 300 confirms the reproducibility and effectiveness of the concave patterned film process in producing uniform, defect-free lithium layers suitable for advanced lithium metal anode manufacturing. The photographic evidence may also validate the controlled separation mechanism and highlight the capability of the concave A-B-A structure to produce sharply defined lithium structures with clean edges and consistent thickness distribution across the patterned areas.

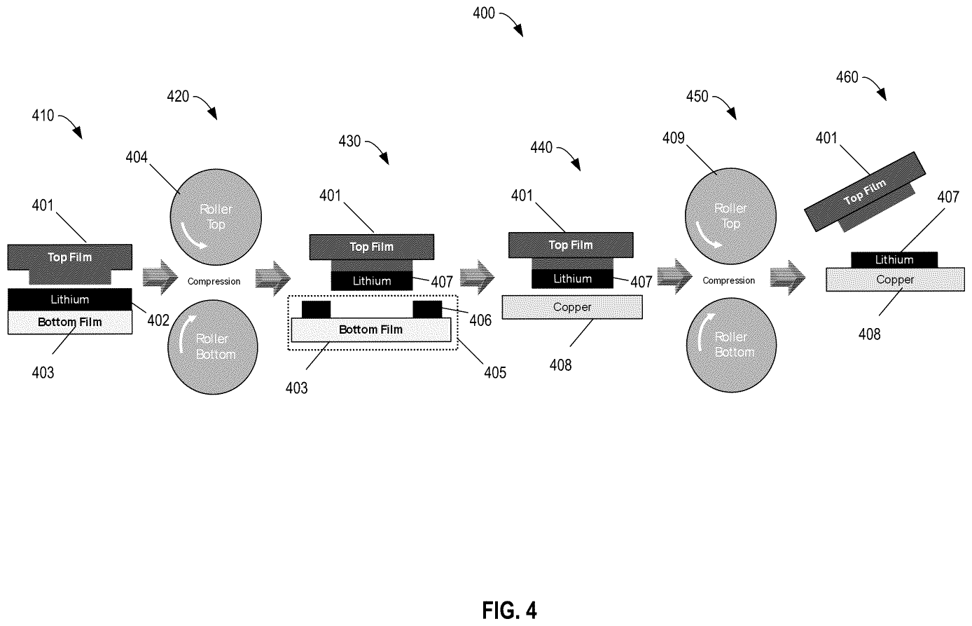

In FIG. 4, a convex patterned film lamination system 400 may be utilized for processing lithium metal through selective lifting and controlled separation operations. The system 400 may receive a layered assembly comprising a top film 401 (e.g., “B-A-B” mask), a lithium layer 402, and a bottom film 403. FIG. 4 depicts a sequence of stages (e.g., stages 410-460) for transferring lithium metal using a convex patterned film structure that concentrates pressure through raised thick regions.

The system 400 may begin at an initial stage 410, where the top film 401, the lithium layer 402, and the bottom film 403 may be positioned in a stacked configuration to form the layered assembly. The top film 401 may comprise a convex patterned structure with varying thickness regions that guide the lamination process. The convex pattern may include raised thick regions that protrude above surrounding thin regions, creating a B-A-B thickness arrangement (as shown in FIG. 1) where the central thick regions concentrate applied forces during compression operations. In some embodiments, the raised A region (thick region) operates as the primary contact zone, while the adjacent thinner B regions allow flexible deformation and maintain stable alignment during movement through the rollers.

The system 400 may proceed to an initial compression stage 420, where the stacked assembly may pass through a roller device 404 (e.g., a single roller or pair of rollers as shown in FIG. 4). During the initial compression stage 420, the roller device 404 may apply pressure to the layered structure, causing the lithium layer 402 to interact with the patterned regions of the top film 401. The convex pattern of the top film 401 may direct compression forces selectively onto the lithium layer 402, with the raised thick regions concentrating pressure on specific portions of the lithium metal during roll pressing and/or compaction.

The convex patterned film may have a raised thick region that locally concentrates pressure, allowing selective lifting and controlled separation of lithium from the roll pressed structure. The concentrated pressure created by the raised sections may cause lithium metal beneath the thick regions to experience stronger compressive forces compared to lithium positioned under the thin regions. This localized pressure distribution may facilitate selective lifting of lithium segments that contact the raised portions of the convex pattern. In some embodiments, the B-A-B structure creates a separation interface based on the height difference between the raised and thin regions.

Following compression, the system 400 may advance to an separation stage 430, where an extracted section 405 comprising the bottom film 403 and lithium side portions 406 may be separated from the rest of the layered assembly. Notably, the lithium side portions 406 and the remaining lithium layer 407 result the selective pressure distribution created by the convex patterned top film 401 and the subsequent separation of the layered assembly. For example, the remaining lithium layer 407 may stay adhered with top film 401 due to the concentrated pressure applied through the raised thick regions. This creates a sharply defined lithium section that reflects the geometry of the convex pattern.

The system 400 may then move to a lamination stage 440, where the remaining lithium layer 407 on the top film 401 may be positioned above a copper substrate 408. Although a copper substrate is described and depicted in FIG. 4, other types of metallic or non-metallic substrates may be used without departing from the scope of the disclosed subject matter. At the lamination stage 440, the patterned lithium structure may be prepared for transfer onto the substrate. The selective separation achieved during the separation stage 430 may result in lithium segments with defined geometric boundaries that correspond to the convex pattern geometry.

The system 400 may continue to a second compression stage 450, where the roller device 409 (e.g., a single roller or a pair of rollers as depicted in FIG. 4) may apply pressure to bond the remaining lithium layer 407 onto the copper substrate 408. The compression may promote adhesion between the lithium metal and the copper substrate 408, thereby facilitating adhesion of the patterned lithium structure to the surface of substrate 408. The mechanical advantage created by the raised pattern during this step allows the lithium to adhere strongly to the copper substrate surface while maintaining a clean boundary that matches the shape defined by the convex mask.

The system 400 may conclude at a final stage 460, where the top film 401 may be removed, leaving the patterned lithium structure (i.e., remaining lithium layer 407) adhered to the copper substrate 408. The final stage 460 demonstrates the completed transfer of lithium metal in a defined pattern without mechanical cutting operations. In some embodiments, the convex patterned film structure may enable selective lithium separation through the concentrated pressure mechanism, producing clean geometric boundaries and uniform thickness distribution across the transferred lithium segments. This precise separation mechanism eliminates irregular edges and prevents uncontrolled spreading of lithium.

The system 400 further illustrates how convex patterned films with raised thick regions enable selective lithium separation and controlled transfer through sequential compression and extraction operations. The convex configuration may provide an alternative approach to the aforementioned concave method/system, utilizing concentrated pressure application rather than guided flow into recessed regions to achieve patterned lithium metal structures.

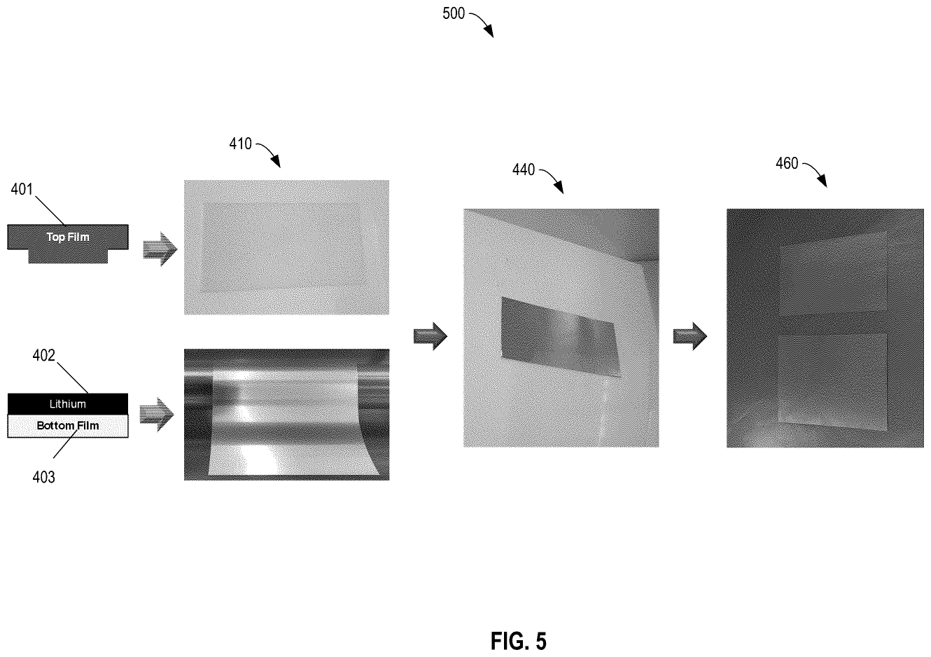

Referring to FIG. 5, diagram 500 illustrates a photographic sequence demonstrating the practical application of the convex patterned film lamination process with lithium metal (e.g., lithium metal foil). Notably, diagram 500 presents a sequence of images that correspond to a number of the stages described in FIG. 4, providing visual evidence of the selective lifting and controlled separation operations achieved through the convex B-A-B structure.

At the initial stage 410, diagram 500 shows the top film 401 positioned above the lithium layer 402, which may rest on the bottom film 403. The top film 401 in this configuration may incorporate the convex pattern with raised thick regions that may concentrate pressure during subsequent compression operations. At the initial stage 410, the three layers may be aligned in preparation for lamination, with the convex pattern of the top film 401 defining the areas where selective lithium separation may occur during roller compression.

Diagram 500 also demonstrates the results of the lamination stage 440, where the assembly has passed through a roller system and the raised thick regions of the top film 401 may apply concentrated pressure to specific portions of the lithium layer 402. During the lamination stage 440, the localized pressure may create a selective lifting effect, causing lithium metal beneath the raised regions to separate from other portions of the lithium layer 402. As a result, the lithium in contact with the raised region becomes bonded to the top film. The convex pattern of the top film 401 may direct the compression forces to achieve controlled separation of lithium segments without requiring mechanical cutting operations. During this process, the thin B regions (supporting layers) allow the patterned film to adjust to the roller contact without damaging the lithium layer.

The selective lifting mechanism may result from the height difference between the raised thick region(s) and the surrounding thin regions of the top film 401. The raised sections may concentrate applied forces onto specific areas of the lithium layer 402, while the thin regions may allow the film to maintain flexibility and controlled movement during the compression process. This differential pressure distribution may enable precise separation of lithium segments that correspond to the geometry of the convex pattern. The thin B regions preserve the overall stability of the film during lifting while preventing unwanted lithium deformation, producing sharply defined structures without mechanical trimming.

At the final stage 460, diagram 500 depicts the completed transfer where the selectively separated lithium segments has been transferred onto a substrate. After separation, the lithium segment carried by the top film (along with the copper substrate) is passed through a secondary roller system where pressure promotes bonding. The top film 401 may be removed after completing the transfer operation, with the lithium segments remaining on the substrate exhibiting defined boundaries that correspond to the geometry of the convex pattern in the top film 401. The two rectangular lithium segments displayed in the photograph confirm that the convex patterned process produces repeatable structures. The bottom film 403 may retain portions of lithium that were not transferred during the selective lifting process.

Diagram 500 may demonstrate the interaction flow between the top film 401, the lithium layer 402, and the bottom film 403 throughout the convex patterned lamination process. The sequence may illustrate how the raised regions of the top film 401 enable selective lithium separation and transfer without requiring mechanical cutting operations. The progression from the initial stage 410 through the lamination stage 440 to the final stage 460 may show the transformation of a continuous lithium layer 402 into patterned lithium structures through controlled pressure application.

The photographic evidence presented in diagram 500 validates the effectiveness of the convex patterned film process in producing uniform lithium segments with clean geometric boundaries. The selective lifting mechanism may produce lithium structures with sharp edges and consistent thickness distribution, demonstrating the capability of the B-A-B convex structure (i.e., thin area-thick area-thin area mask) to achieve precise and reproducible pattern formation during roll press lamination operations.

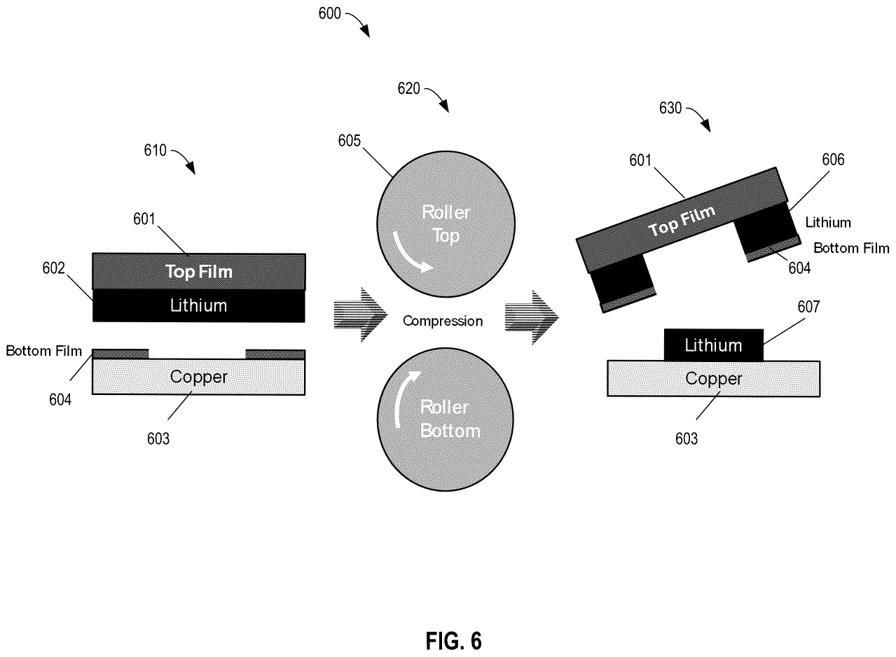

Referring to FIG. 6, a direct patterned lamination system 600 may be utilized where a patterned film may be positioned directly on a metallic substrate to achieve simultaneous pattern formation, separation, and bonding operations. FIG. 6 illustrates a metal direct lamination process of a layered assembly including a top film 601, a lithium layer 602, and a metallic substrate (e.g., copper foil substrate 603) that includes a bottom film 604 on its surface. The disclosed system 600 may enable pattern formation, separation, and bonding to occur in a single lamination step, thereby eliminating the need for intermediate carrier layers or sequential processing operations. As used herein, the “A-Metal-A” structure refers to the arrangement in which a patterned film (e.g., bottom film 604) is positioned directly on the metal substrate layer that supports the lithium metal during transfer.

The direct lamination process conducted by system 600 may begin at an initial stage 610, where the top film 601 carrying the lithium layer 602 may be positioned above the copper substrate 603. Although a copper substrate is described and depicted in FIG. 6, other types of metallic or non-metallic substrates may be used without departing from the scope of the disclosed subject matter. At stage 610, the components may be aligned to form a layered assembly prior to the compression operations conducted at stage 620. In some embodiments, the bottom film 604 may include a patterned structure that defines the intended lithium placement geometry (i.e., the region where the lithium will remain after lamination), while the lithium layer 602 may be prepared for direct transfer onto the surface of copper substrate 603 via the openings or recesses in bottom film 604. The outer A regions of the mask layer (e.g., bottom film 604) represent thicker support areas that regulate pressure distribution, while the central metal contact zone provides a direct path for lithium attachment onto the copper substrate surface.

In compression stage 620, a roller device 605 (e.g., a single roller or a pair of rollers as shown in FIG. 6) may apply pressure to the layered assembly. As the layered structure passes between the top and bottom rollers during the compression stage 620, the roller device 605 may apply pressure through the films and directly onto the lithium layer 602. The patterned structure of the bottom film 604 may guide the lithium placement during compression, with thick and thin regions creating differential pressure zones that determine the final lithium geometry on the substrate surface. The thick “A regions” of the mask layer (e.g., bottom film 604) restrict deformation outside the desired pattern, while the central metal area promotes strong bonding between lithium and the copper foil. Excess lithium that lies beyond the patterned boundary is compressed and separated at the edges. This step produces a clean transition between the desired lithium pattern and the surrounding copper surface. A lithium side portion 606 may represent excess lithium material that extends beyond the intended pattern region during compression operations.

At separation stage 630, the top film 601 may be separated (e.g., lifted away) from the remaining portions of the layered assembly (e.g., lithium layer 602 and copper substrate 603). In FIG. 6, a remaining lithium layer 607 is shown adhered to the copper substrate 603 in a pattern that corresponds to the geometry defined by the patterned film structure of the bottom film 604. The lithium side portions 606 may remain adhered to the top film 601 and the bottom film 604 during the separation process, thereby leaving the remaining lithium layer 607 with clean geometric boundaries (as defined by the recesses of bottom film 604, i.e., the A-Metal-A structure) on the surface of copper substrate 603. The patterned film detaches cleanly, leaving behind a lithium layer that reproduces the geometric outline defined by the A-Metal-A structure. No slitting or mechanical trimming is required because the mask layer performed both the pattern definition and the edge separation during the lamination step. Notably, the lithium remains firmly attached to the copper due to the direct bonding that occurred during roller compression.

System 600 demonstrates that the A-Metal-A direct lamination process provides a streamlined approach for placing lithium metal onto a metallic substrate. By allowing the patterned film (e.g., bottom film 604) to rest directly on the copper foil substrate before compression, the process achieves patterning, transfer, and cleanup in a single roller pass. This method reduces process complexity, eliminates additional and/or intermediate carrier layers, and supports a highly uniform and defect free lithium structure suitable for advanced battery manufacturing.

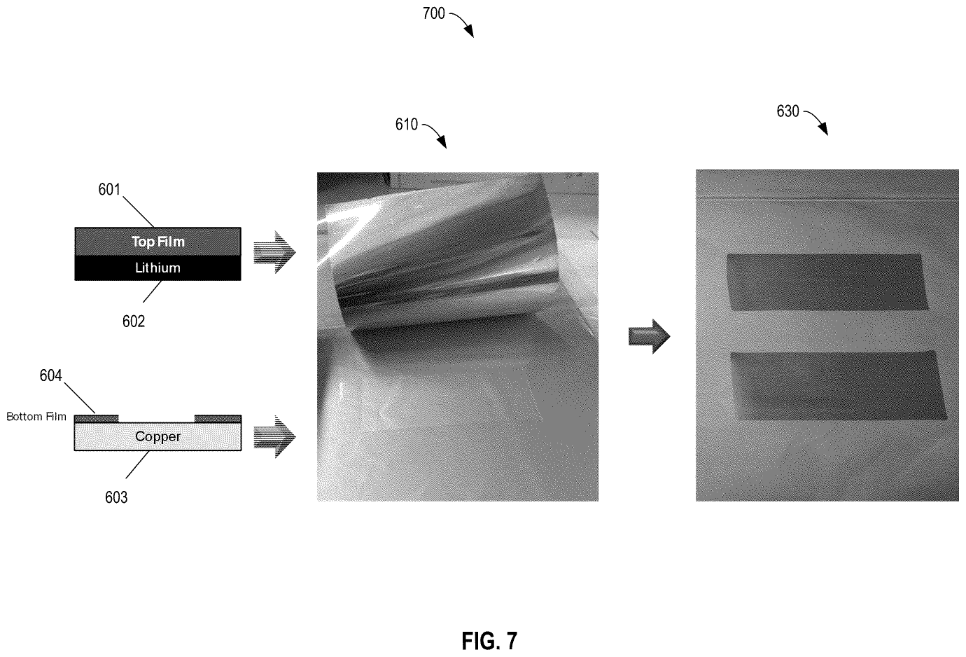

Referring to FIG. 7, diagram 700 provides a photographic sequence demonstrating the practical application of the direct lamination process using the A-Metal-A structure as shown in FIG. 6. Diagram 700 presents visual evidence of the simultaneous pattern formation, separation, and bonding operations achieved through direct contact between the patterned film and the metallic substrate (e.g., a patterned mask film placed on a metal foil, typically copper, before compression). More specifically, this configuration shown in FIG. 7 integrates pattern definition, lithium transfer, and final attachment to the metal substrate within a single lamination sequence. The A-Metal-A structure describes an arrangement in which the patterned film is directly supported by the metal foil during the lamination step.

In FIG. 7, diagram 700 illustrates the progression from the lamination stage 610, where the top film 601 may be positioned on top of the lithium layer 602, which in turn may be placed on the bottom film 604 and copper substrate 603. In stage 610, the components may be brought into direct contact prior to compression operations. The bottom film portion 604 may be located on top of the copper substrate 603. The thicker A regions of the bottom film 604 provide structural rigidity and control pressure distribution during compression, while the central region (e.g., openings in bottom film 604) directly influences the bonding between lithium and copper. The arrangement demonstrates the A-Metal-A configuration where the patterned film (e.g., bottom film 604) may contact the metallic substrate directly, enabling efficient pressure transmission through the film structure to the lithium layer. This configuration allows the bottom patterned film 604 to regulate how pressure is applied to the lithium layer during the roller process. Because the patterned film is already resting on the copper foil, the lamination step will perform lithium patterning, separation of excess material, and direct bonding in a single operation.

Diagram 700 shows the transition to the separation stage 630, where the top film 601 may be separated from the remaining lithium layer 607 and the copper substrate 603. During the separation stage 630, the remaining lithium layer 607 may remain adhered to the copper substrate 603 after the top film 601 (and adhered lithium side portions 606 and bottom film layer 604) is removed. Excess lithium located outside the patterned region is separated at the boundaries of the film (e.g., edges of bottom film 604). The lithium now remains firmly attached to the copper substrate as two rectangular patterned sections. These segments reflect the geometry controlled by the A Metal A pattern of the bottom film layer 604. The clean edges and uniformity of the lithium layer confirm that patterning, transfer, and trimming occurred simultaneously during the roller pass without requiring additional slitting or post processing.

The photographs of FIG. 7 further demonstrate that the direct lamination process may achieve strong adhesion between the lithium metal and the copper substrate through the concentrated pressure application enabled by the direct contact configuration.

The visual progression presented in the diagram 700 illustrates the effectiveness of the direct A-Metal-A lamination method in producing uniform adhesion, efficient material usage, and clean boundary definition, thereby demonstrating the suitability of this method for high precision lithium metal anode manufacturing. The lithium layer 602 may exhibit precise geometric boundaries that correspond to the pattern defined by the bottom film 604, demonstrating the capability of the direct lamination approach to achieve accurate pattern transfer without mechanical cutting operations. The clean separation of the top film 601 from the adhered lithium layer 602 may indicate that the bonding between the lithium and the copper substrate 603 may be stronger than the adhesion between the lithium and the patterned film (e.g., bottom film 604).

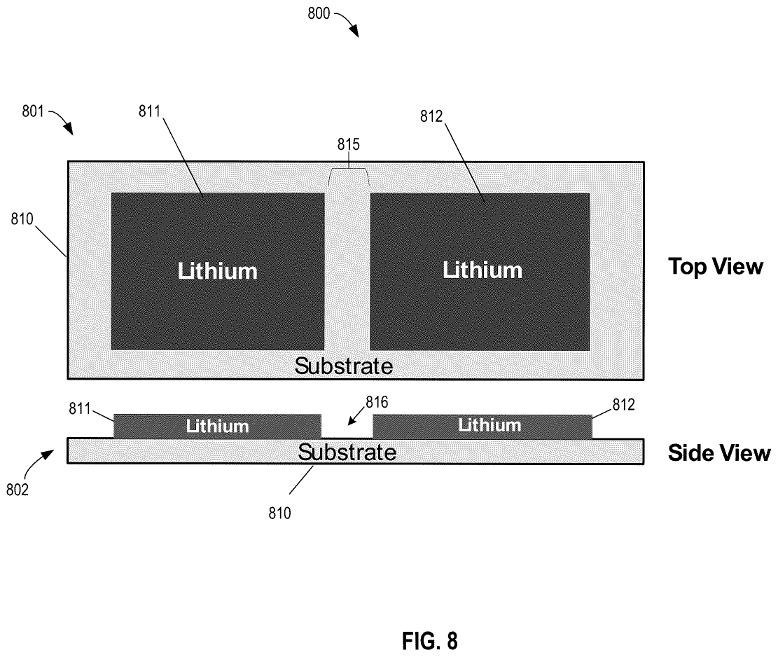

Referring to FIG. 8, diagram 800 illustrates patterned lithium metal structures positioned on a substrate with defined spacing between individual lithium segments/regions. The diagram 800 includes a top view 801 and a side view 802 that demonstrate how the patterned lamination processes may produce intermittent lithium patterns with controlled geometric configurations and precise spacing between segments. Notably, the arrangement represents the final structure produced by the patterned lamination methods described in the earlier figures. Each lithium section is transferred onto the substrate according to the geometric boundaries defined by the patterned film, resulting in uniform shapes, clean edges, and consistent thickness across the entire patterned area.

The top view 801 displays a substrate 810 with two rectangular lithium segments positioned on the surface of substrate 810. A first lithium section 811 and a second lithium section 812 may be separated by a defined gap 815, creating an intermittent pattern where each lithium segment may exhibit uniform dimensions and clean geometric boundaries. The spacing (e.g., gap 815) between the first lithium section 811 and the second lithium section 812 may be controlled by the geometry defined by the thick and thin regions of the patterned films during the lamination process. The uniform thickness and consistent edge definition of both lithium segments may demonstrate the precision achievable through the patterned film guided lamination approach.

The side view 802 may provide a cross-sectional representation of the same patterned structure shown in the top view 801. The substrate 810 may form the base layer, with the first lithium section 811 and the second lithium section 812 positioned on top of the surface of substrate 810. More specifically, the side view 802 demonstrates that each lithium segment may rest directly on the substrate surface, with a clear separation zone 816 (which is horizontally defined by gap 815) extending to the substrate 810 surface between the two lithium sections. This configuration may confirm that lithium metal may be placed only in designated patterned regions as defined by the film geometry, with no lithium material present in the spacing areas between segments.

The configuration shown in FIG. 8 demonstrates that the patterned lamination process enables precise control over the aspect ratio, size, and shape of the lithium metal transferred onto the substrate. Namely, the intermittent lithium pattern structure demonstrated in the diagram 800 may illustrate the process flexibility to create various geometric configurations without requiring mechanical cutting equipment. The geometry of the thick and thin regions of the patterned films may define intermittent lithium structures comprising two or more separated lithium segments. The spacing, dimensions, and arrangement of the lithium segments may be determined by the pattern design incorporated into the films, enabling manufacturers to produce customized lithium geometries for specific battery applications.

The approach may enable rapid pattern modification for different battery specifications through changes to the patterned film design rather than modifications to mechanical cutting equipment. This reduction in equipment requirements significantly lowers the initial capital investment associated with early-stage lithium metal production lines. The manufacturer is not required to install slitter systems or trimming modules, which are typically expensive and introduce additional complexity into the workflow. Manufacturers may adapt to various cell geometries, spacing requirements, and segment dimensions by preparing films with corresponding pattern configurations. This flexibility may support both pilot-scale development and mass production environments where battery manufacturers may frequently modify electrode formats to meet diverse application requirements.

The patterned lamination processes may also support complete lithium recycling through chemical or physical removal methods for residual lithium material that may remain on the films after transfer operations. Residual lithium remaining on the patterned films after lamination may be removed through chemical dissolution or physical separation, enabling complete recycling and reducing scrap generation. This approach enables complete recovery of non-transferred lithium metal. As a result, process scrap, by products, and waste materials are minimized. The residual lithium may exist as a thin, uniform layer on the film surfaces that may be recovered through controlled removal processes, providing a recycling pathway that reduces material waste and improves resource utilization. The recycling capability may contribute to environmentally favorable manufacturing practices while reducing operating costs associated with material loss during production operations. The design flexibility, reduced equipment dependency, and full recyclability of residual lithium make the method a streamlined and sustainable solution for next generation of lithium metal foil manufacturing.

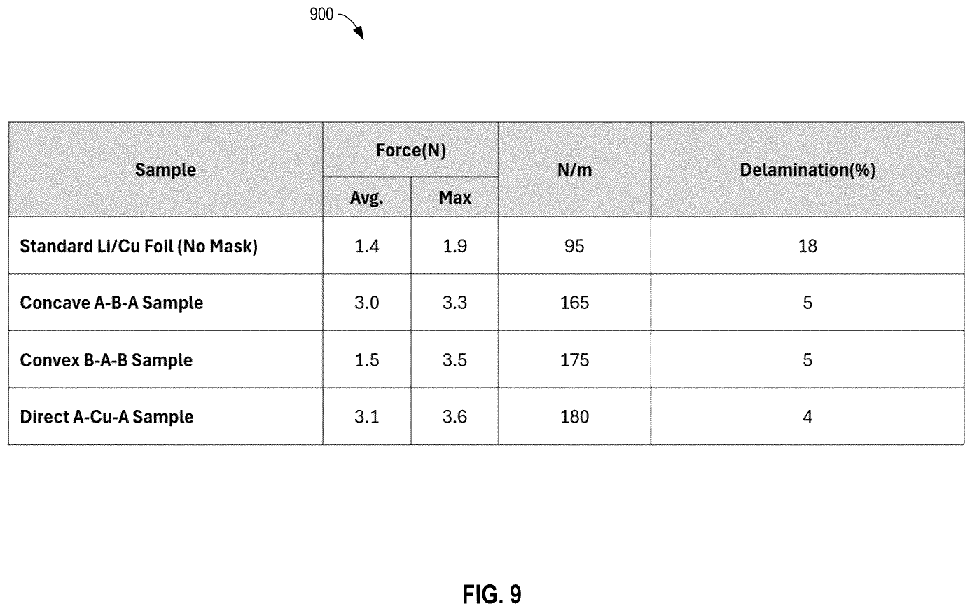

In FIG. 9, a table 900 presents peel strength measurement data that may demonstrate the adhesion performance differences between standard lithium to copper lamination and the patterned film guided lamination methods. The data in table 900 compares four sample types: a Standard Li/Cu Foil sample prepared without a patterned mask, a Concave A-B-A Sample, a Convex B-A-B Sample, and a Direct A-Metal-A Sample (e.g., A-Copper-A sample). The comparative data shown in table 900 provides quantitative evidence of the enhanced bonding characteristics achieved through the patterned lamination approaches.

The peel strength evaluation may be conducted using standardized testing methodology to ensure reliable and reproducible measurements across all sample types. The test samples may have dimensions of 20 millimeters (mm)×45 mm (corresponding to 2.0 cm by 4.5 cm). In some embodiments, polyimide adhesive tape may be applied to the lithium coated copper surfaces under controlled conditions, including a pressurization level of 1.0 kilogram per square millimeter and an adhesion pressure of 9.8 kilopascals (9800 newton per square meter). The pressurization may be maintained for a specified duration (e.g., 5 minutes) before peeling operations commence.

The peel testing may be performed following ASTM D3330 procedures to ensure standardized measurement conditions and reliable data collection. The testing may be conducted using a tensile testing machine, such as a Nextech DFS500N, configured to execute one hundred eighty-degree (180°) peel tests. The testing methodology may include controlled peeling motion at a constant speed of 1 centimeter per second (cm/s) to measure the force required to separate the polyimide tape from the lithium surface. The force measurements may be recorded in newtons, while peel strength values may be calculated and expressed in newtons (N) per meter (m). Delamination percentages may be determined by evaluating the proportion of lithium material that remains attached to the tape after peeling operations.

The Standard Li/Cu Foil sample prepared without a patterned mask may exhibit baseline adhesion characteristics representative of conventional uniform lamination processes. The sample may show an average peel force of 1.4 newtons and a maximum peel force of 1.9 newtons. The normalized peel strength may be 95 newtons per meter, while the delamination rate may be 18 percent. These measurements may reflect the limitations of uniform compression processes where pressure may not be selectively concentrated at the lithium-copper interface.

The Concave A-B-A Sample may demonstrate substantial improvement in adhesion performance compared to the standard sample. The concave patterned lamination method may produce an average peel force of 3.0 newtons and a maximum peel force of 3.3 newtons. The normalized peel strength may increase to 165 newtons per meter, while the delamination rate may be 5 percent. The enhanced performance may result from the recessed patterned regions that focus compression load directly into the intended lithium areas, creating stronger mechanical bonding with the copper substrate.

The Convex B-A-B Sample may exhibit distinct adhesion behavior characterized by selective pressure concentration through the raised thick regions. The sample may show an average peel force of 1.5 newtons and a maximum peel force of 3.5 newtons, with a normalized peel strength of 175 newtons per meter and a delamination rate of 5 percent. The elevated maximum force may result from the concentrated pressure application through the thick raised pattern regions, while the average force may remain lower due to the partial pressure absorption by the raised structure during compression operations.

The Direct A-Cu-A Sample may demonstrate the highest adhesion performance among all tested configurations. The direct lamination method may produce an average peel force of 3.1 newtons and a maximum peel force of 3.6 newtons, with a normalized peel strength of 180 newtons per meter. The delamination rate may be 4 percent, indicating that nearly all lithium material may remain attached to the copper substrate following peeling operations. The superior performance may result from the direct contact configuration that enables effective pressure confinement and produces robust interfacial bonding between the lithium and copper materials.

The peel strength data in table 900 may confirm that all patterned lamination methods may produce peel strength at least fifty percent greater than that achieved through lamination performed without a patterned film. It should be noted that the adhesion values of the Standard Li/Cu Foil sample (e.g., 95 N/m) are representative of conventional lamination processes used to create intermittent electrode designs (e.g., via uniform rolling followed by mechanical slitting). Accordingly, in some embodiments, the patterned film is configured to provide a peel strength at least 50% greater than that of a lamination performed using an intermittent electrode design without the patterned film. The Concave A-B-A Sample may achieve a peel strength increase of approximately 74 percent compared to the standard sample, while the Convex B-A-B Sample may achieve an increase of approximately 84 percent. The Direct A-Cu-A Sample may demonstrate the highest improvement with a peel strength increase of approximately 89 percent compared to the standard lamination method.

The delamination rate measurements may demonstrate that all patterned lamination methods may achieve delamination rates less than ten percent. The Concave A-B-A Sample and Convex B-A-B Sample may both achieve delamination rates of 5 percent, while the Direct A-Cu-A Sample may achieve the lowest delamination rate of 4 percent. These reduced delamination rates may indicate that the patterned film guided lamination processes may produce more uniform and reliable bonding compared to standard lamination methods, where the delamination rate may reach 18 percent.

The quantitative peel strength results may verify that patterned film guided lamination may significantly improve adhesion between lithium metal and copper substrates compared to conventional non-patterned processing methods. The controlled pressure distribution created by the patterned films may concentrate compression forces at specific interface regions, promoting stronger mechanical bonding and reducing the likelihood of premature delamination during handling or subsequent processing operations. The enhanced adhesion characteristics may contribute to improved mechanical stability and reliability of lithium metal structures in battery applications.

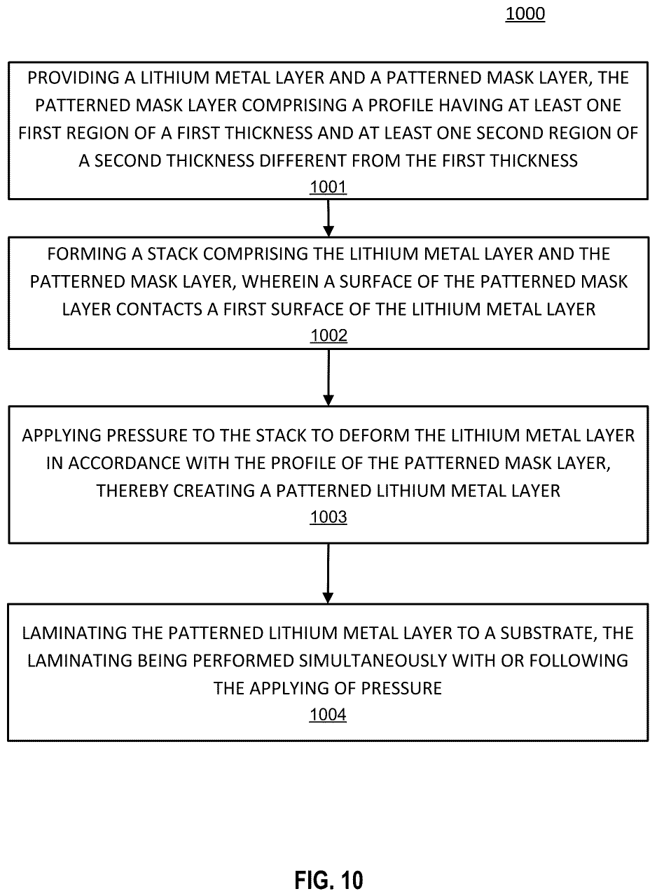

Referring to FIG. 10, a method 1000 may provide a comprehensive manufacturing approach for producing patterned lithium metal structures using controlled pressure distribution through patterned mask layers. The method 1000 may integrate the concave, convex, and direct lamination configurations previously described to achieve precise lithium metal fabrication without mechanical slitting, punching, notching, or trimming operations. The method 1000 may demonstrate a sequential process flow that encompasses the principles underlying all patterned film guided lamination approaches.

At step 1001, a lithium metal layer and a patterned mask layer are provided. In the step 1001, the patterned mask layer may comprise a profile having at least one first region of a first thickness and at least one second region of a second thickness different from the first thickness. In some embodiments, the first region may correspond to the thick regions 110, 112, 121 described in the concave and convex configurations disclosed above, while the second region may correspond to the thin regions 111, 120, 122. The thickness difference between the first and second regions may establish controlled pressure distribution zones that determine the final geometry and placement of lithium metal during subsequent processing operations.

The patterned mask layer provided in the step 1001 may incorporate any of the previously described configurations, including the concave A-B-A structure where thin regions may form recessed cavities between surrounding thick regions, or the convex B-A-B structure where thick regions may form raised sections above surrounding thin regions. The profile geometry may be selected based on the desired lithium pattern characteristics and the specific lamination approach to be employed during manufacturing operations.

The method 1000 proceeds to step 1002, which may involve forming a stack (e.g., a layered assembly) comprising the lithium metal layer and the patterned mask layer. In step 1002, a surface of the patterned mask layer may contact a first surface of the lithium metal layer, establishing the interface through which controlled pressure distribution may be achieved during subsequent compression operations. In some embodiments, this step may generally comprise positioning the lithium metal layer adjacent to the patterned film. The stack formation may correspond to the initial stages 210, 410 respectively described in FIGS. 2 and 4 of the concave and convex lamination systems, where the lithium layer may be positioned between or adjacent to the patterned films in preparation for compression.

The stack formed in step 1002 may include additional components depending on the specific lamination configuration being employed. For concave and convex configurations, the stack may include the bottom films 203, 403 that serve as carrier layers during the lamination process. For direct lamination configurations, the stack may include a metallic substrate (e.g., copper substrate 603 shown in FIG. 6) positioned directly beneath the lithium metal layer, enabling simultaneous pattern formation and substrate bonding operations.

The method 1000 continues to step 1003, where pressure may be applied to the stack to deform the lithium metal layer in accordance with the profile of the patterned mask layer. The step 1003 may create a patterned lithium metal layer through controlled deformation guided by the thickness variations in the mask layer profile. For example, applying pressure through roll pressing may direct the lithium metal to move, deform, accumulate, or separate according to the geometry defined by the patterned film. The pressure application may correspond to the compression operations performed by the roller devices 204, 404, 605 described in the various lamination systems depicted in FIGS. 2, 4, and 6, where compression forces may be directed through the patterned mask layers to achieve selective lithium placement and separation.

During step 1003, the first regions of the patterned mask layer may restrict lateral spreading of lithium metal (i.e., control movement) and may provide structural boundaries that define areas where lithium may be guided during compression. The second regions may allow selective lithium accumulation in concave configurations or may provide flexible support areas in convex configurations. Furthermore, the raised regions in convex configurations may concentrate pressure to separate lithium sections. The pressure application may result in lithium deformation that conforms to the geometric boundaries established by the mask layer profile, producing patterned lithium structures with defined edges and uniform thickness distribution.

The method 1000 proceeds to a step 1004, which may involve laminating and/or transferring the patterned lithium metal layer to a substrate. The step 1004 may be performed simultaneously with or following the pressure application described in step 1003. The laminating operation may transfer the patterned lithium metal layer from the mask layer to the substrate surface, establishing mechanical bonding between the lithium and substrate materials. The substrate may comprise metallic materials such as the copper substrates 208, 408, 603 described in the various lamination systems depicted in FIGS. 2, 4, and 6, or may comprise nonmetallic materials suitable for specific lithium metal applications.

In some embodiments, the simultaneous laminating (and/or transferring) approach described in the step 1004 may correspond to the direct A-Metal-A configuration, where pattern formation, separation, and substrate bonding may occur concurrently during a single compression operation. Alternatively, the sequential laminating approach may correspond to the concave A-B-A and convex B-A-B configurations, where the patterned lithium metal layer may be transferred to the substrate through secondary compression operations following initial pattern formation.

In some embodiments, the method 1000 may integrate all previously described lamination configurations and processing approaches into a unified manufacturing framework. The step 1001 may accommodate the various patterned mask layer designs including concave, convex, and direct contact configurations. The step 1002 may support different stack arrangements depending on the selected lamination approach. The step 1003 may enable controlled pressure application through any of the described roller systems and compression mechanisms. The step 1004 may facilitate substrate bonding through either simultaneous or sequential laminating operations.

The method 1000 may achieve patterned lithium metal fabrication without requiring mechanical slitting, punching, notching, or trimming operations through the controlled pressure distribution mechanism established by the patterned mask layer profile. The thickness variations between the first and second regions may direct lithium deformation and placement during compression, eliminating the need for subsequent mechanical cutting operations to achieve desired geometric configurations. The approach may enable rapid pattern modification through changes to the mask layer design rather than modifications to mechanical cutting equipment, supporting manufacturing flexibility and cost reduction.

The method 1000 may produce patterned lithium metal structures with enhanced adhesion characteristics compared to conventional uniform lamination processes. The controlled pressure distribution achieved through the step 1003 may concentrate compression forces at specific interface regions, promoting stronger mechanical bonding between the lithium metal and substrate materials. The enhanced bonding may result in peel strength improvements of at least fifty percent compared to non-patterned lamination methods, while achieving delamination rates less than ten percent as demonstrated in the comparative peel strength data (e.g., shown in table 900 of FIG. 9).

A number of implementations have been described. Nevertheless, it will be understood that various modifications may be made without departing from the spirit and scope of the disclosure. Accordingly, other implementations are within the scope of the following claims.

1. A patterned film for guiding lithium metal during a lamination process, comprising:
a first region having a first thickness; and
a second region having a second thickness different from the first thickness, wherein the first region and the second region are configured to direct selective placement, deformation, separation, and transfer of lithium metal onto a substrate during roll pressing without mechanical slitting, punching, notching, or trimming.

2. The patterned film of claim 1, wherein the first region comprises a thick region and the second region comprises a thin region.

3. The patterned film of claim 2, wherein the thin region forms a recessed cavity between surrounding thick regions in a concave configuration.

4. The patterned film of claim 2, wherein the thick region forms a raised section above surrounding thin regions in a convex configuration.

5. The patterned film of claim 1, wherein the patterned film comprises a thickness between 5 micrometers and 5 centimeters.

6. The patterned film of claim 1, wherein the patterned film comprises a material selected from polymers, metals, composites, ceramics, or multilayer structures.

7. The patterned film of claim 6, wherein the material comprises a polymer selected from polyester, polyethylene, polypropylene, polyacrylonitrile, polyvinylidene fluoride, polyvinyl chloride, polytetrafluoroethylene, nylon, polyurethane, cellulose films, lignin-based films, rubber-based sheets, fluoropolymer compositions, or combinations thereof.

8. A method for forming a patterned lithium structure, comprising:
positioning a lithium metal layer adjacent to a patterned film having at least one thick region and at least one thin region;
applying pressure through roll pressing to direct the lithium metal to move, deform, accumulate, or separate according to a geometry defined by the thick region and the thin region of the patterned film; and
transferring the lithium metal positioned within a patterned region onto a substrate without mechanical slitting, punching, notching, or trimming.

9. The method of claim 8, wherein the patterned film comprises a concave arrangement having a recessed thin region that receives lithium during compression.

10. The method of claim 9, wherein excess lithium residing outside the thin region is retained on a release film for subsequent recovery.

11. The method of claim 8, wherein the patterned film comprises a convex arrangement having a raised thick region that concentrates pressure for selective separation.

12. The method of claim 11, wherein the raised thick region generates localized pressure that produces selective lifting of the lithium metal.

13. The method of claim 8, wherein the substrate comprises a metallic material selected from copper, aluminum, nickel, stainless steel, or combinations thereof.

14. The method of claim 13, wherein the patterned film comprises an A-Metal-A configuration positioned directly on the metallic material, and wherein the applying pressure and the transferring are performed simultaneously in a single pass through a roll press.

15. A roll press-based fabrication system for producing patterned lithium metal structures, comprising:
a patterned film having controlled thickness regions including at least one thick region and at least one thin region;
a lithium metal feed layer;
a substrate; and
a roller unit configured to apply selective pressure that transfers lithium metal according to a pattern of the patterned film without mechanical slitting, punching, notching, or trimming.

16. The roll press-based fabrication system of claim 15, wherein the roller unit is configured to apply pressure between one megapascal and two hundred megapascal.

17. The roll press-based fabrication system of claim 15, wherein the substrate comprises a metallic material selected from copper, aluminum, nickel, stainless steel, magnesium, zinc, tin, antimony, beryllium, bismuth, lead, cadmium, chromium, cobalt, manganese, titanium, zirconium, hafnium, vanadium, molybdenum, tungsten, silver, gold, indium, gallium, germanium, palladium, platinum, silicon, metal coated polymer films, or combinations thereof.

18. The fabrication system of claim 15, wherein the patterned film is configured to provide a peel strength at least 50% greater than that of a lamination performed using an intermittent electrode design without the patterned film, or wherein a delamination rate of lithium metal remaining on the patterned film is less than 10%.

19. The roll press-based fabrication system of claim 15, wherein the patterned film comprises a concave arrangement having a recessed thin region configured to receive lithium metal during compression, or a convex arrangement having a raised thick region configured to concentrate pressure for selective lithium separation.

20. The roll press-based fabrication system of claim 19, wherein the system is configured to produce intermittent lithium patterns comprising two or more separated lithium segments with defined spacing between the segments.
